(19) United States
(12) Patent Application Publication
(10) Pub. No.: US 2025/0232703 A1
(43) Pub. Date: Jul. 17, 2025

(54) Driving structure for display panel

(71) Applicant: Sitronix Technology Corporation, Hsinchu County (TW)

(72) Inventor: Chung-Hsin Su, Hsinchu County (TW)

(21) Appl. No.: 19/021,307

(22) Filed: Jan. 15, 2025

Related U.S. Application Data
(60) Provisional application No. 63/620,897, filed on Jan. 15, 2024.

(51) Int. Cl. G09G 3/20; G09G 3/32

(52) U.S. Cl. CPC G09G 3/2007; G09G 3/32; G09G 2310/08; G09G 2330/021

(57) ABSTRACT

The present application discloses a driving structure for display panel, which comprises a controller and at least one driver. The controller is disposed on a display panel, the controller generates a data signal and a display clock signal. The at least one driver is disposed on a display panel, the at least one driver receives the data signal and a display clock signal, the controller adjusts a frequency of the display clock signal to correspond the data signal.

### FIELD OF THE INVENTION

The present application relates to a driving structure, particularly to a driving structure for a display panel.

### BACKGROUND OF THE INVENTION

Refer to FIG. 1, which illustrates a schematic diagram of a linear curve and a gamma curve. Lower bit pixel data divides the grayscale of the panel into a plurality of levels, but the levels are not linear as shown in the curve of the left diagram, but rather curved as shown in the curve of the right diagram, thereby, higher bits are required to resolve the grayscales at the low brightness. For example, with 8-bit pixel data, 14 bits are necessary to resolve the grayscales at the low brightness, otherwise, level overlapping issues will be occurred. At medium brightness to high brightness, for every increased level in 8-bit pixel data (e.g., from 00000000 to 00000001), tens or hundreds of levels are needed in 14-bit, and as the number of bit for representing display clock signal data increases, the operating frequency of components on the display panel also increases.

Taking a display panel with a plurality of micro drivers as an example, typically equipped with a large number of micro drivers, for display clock signal, each additional bit doubles the operating frequency, the dynamic power of the micro drivers is also doubled, and the area of the micro drivers also increases, thereby increasing the volume and load of the overall system, therefore, a technical solution to overcome these issues is needed.

### SUMMARY

An objective of the present application is to provide a driving structure for a display panel, comprising a controller and at least one driver, the controller adjusts the frequency of a display clock signal to correspond a data signal, making the number of bits of the display clock signal be equal to or approximate the number of bits of the pixel data, thereby overcoming the aforementioned technical issues.

An objective of the present application is to provide a driving structure for a display panel, wherein the controller adjusts the frequency of the display clock signal to enable lower bit display clock signals for achieving higher bit data resolution capabilities.

An objective of the present application is to provide a driving structure for a display panel, where the controller adjusts the frequency of the display clock signal data to reduce the dynamic power of the display panel and decrease load of the overall system.

An objective of the present application is to provide a driving structure for a display panel, wherein the controller adjusts the frequency of the display clock signal data to allow the use of electronic components with lower bit counts, reduce the area occupied by electronic components, and decrease the overall system volume.

### BRIEF DESCRIPTION OF THE DRAWINGS

FIG. 1: which is a schematic diagram of linear curve and gamma curve;

FIG. 2: which is a schematic diagram of a driving structure for a display panel according to the present application;

FIG. 3: which is a partial schematic diagram of the driving structure according to an embodiment of the present application;

FIG. 4: which is a schematic diagram of the display clock signal, reference display clock signal, and activating clock signal according to an embodiment of the present application;

FIG. 5: which is a schematic diagram of the display clock signal and reference display clock signal according to another embodiment of the present application;

FIG. 6: which is a schematic diagram of the display clock signal and reference display clock signal according to another embodiment of the present application.

### DETAILED DESCRIPTION

To provide the esteemed reviewers with a further understanding and recognition of the features and effects achieved by the present application, detailed descriptions along with embodiments are provided as follows:

Certain terms used in the specification and claims refer to specific components, and those skilled in the art should understand that manufacturers may use different terms for the same component. Furthermore, the specification and claims do not distinguish components according to the difference in names but on the technical differences in the components as a whole. The term “comprising” mentioned throughout the specification and claims is an open-ended term and should be interpreted as “including but not limited to.” Moreover, the term “coupling” here includes any direct and indirect means of connection. Therefore, if the text describes a first device coupled to a second device, it means that the first device may be directly connected to the second device, or indirectly connected to the second device through other devices or means of connection.

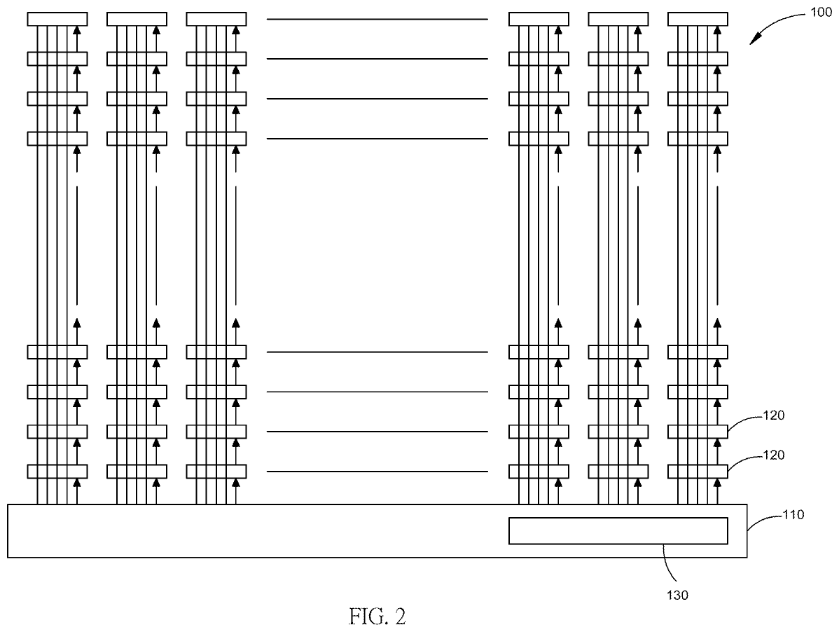

Please refer to FIG. 2, which is a schematic diagram of the driving structure for a display panel according to the present application. The driving structure of the present application is configured to drive a display panel 100 for displaying images. The display panel 100 includes a controller 110 and at least one driver 120, with a plurality of drivers 120 exemplified in this embodiment. The controller 110 is set up on the display panel 100 and coupled to the drivers 120. The drivers 120 are arranged on the display panel 100, and the drivers 120 in the same row are coupled in series.

In this embodiment, the controller 110 may generate signals such as data signals, data clock signals, display clock signals, and enable signals (not shown in the figure). The controller 110 sends these data signals, data clock signals, display clock signals and enable signals to at least one driver 120. In this embodiment, the aforementioned signals are sent to the drivers 120 adjacent to the controller 110.

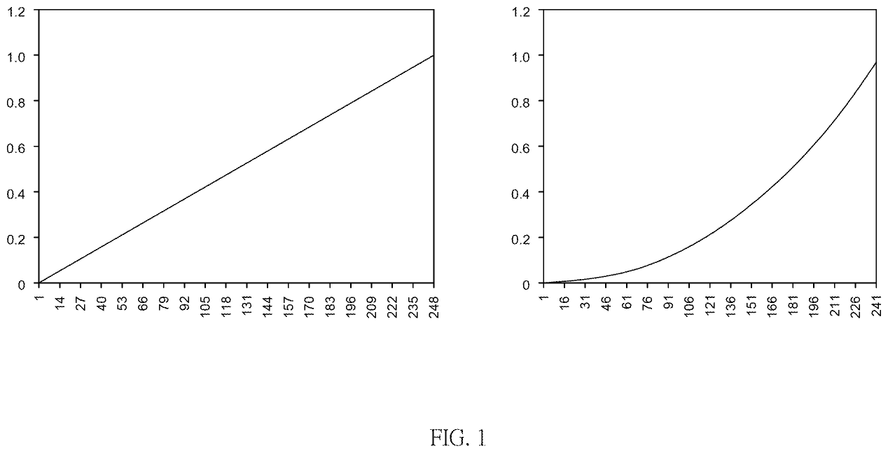

In this embodiment, the data signal is the display data, which may be a serial data and includes a plurality of pixel data for displaying images on display panel 100. The amount of data lines transmitting the data signal may be any number according to the size of the panel or the application. The data clock signal is a timing signal, and the drivers 120 receive the data signal according to the timing of the data clock signal. For instance, the drivers 120 include a first driver and a second driver, the first driver is connected to the second driver in series. The first driver begins to receive the data signal according to the timing of the data clock signal after receiving the data clock signal, and then transferring the data clock signal to the second driver for driving the second driver beginning to receive the data signal. The display clock signal is a timing signal, such as a pulse width modulation (PWM) signal, and the drivers 120 drive the light-emitting components to turn on or off according to the timing of the display clock signal. The enable signal is a timing signal, and the drivers 120 begin to receive the data signal and display clock signal according to the enable signal. For example, when the driver 120 receive the enable signal, which indicates that the driver 120 is selected and drives the driver 120 beginning to receive the data signal and display clock signal for driving the light-emitting components to display images. Once the current driver of the drivers 120 completes the transmission of display data, the current driver of the drivers 120 will output another enable signal to the next driver of the drivers 120, allowing the next driver of the drivers 120 to receive the enable signal and begin operation. The current driver of the drivers 120 is coupled to the next driver of drivers 120 in series, as shown in FIG. 1.

In an embodiment, controller 110 includes a display clock signal generator 130, which generates the display clock signal according to the content of the data signal.

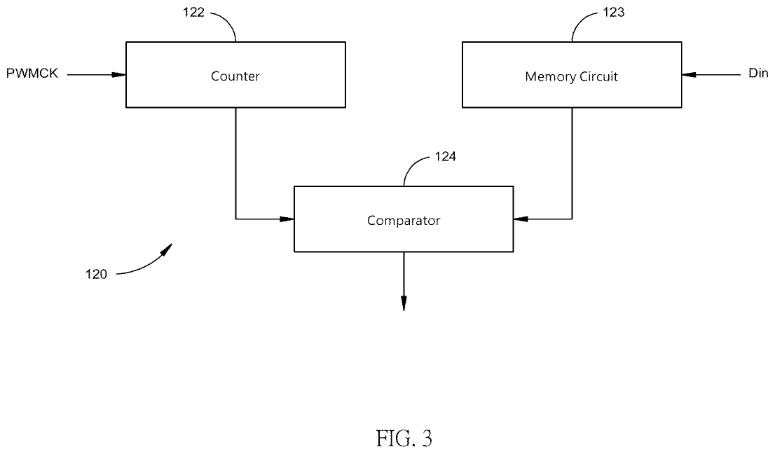

Please refer to FIG. 3, which is a partial schematic diagram of the driving structure according to an embodiment of the present application. In this embodiment, at least one driver 120 includes a counter 122, a memory circuit 123, and a comparator 124, but the components included in the driver 120 of the present application are not limited to these. The counter 122 receives the display clock signal data PWMCK and generates a counting signal to the comparator 124, while the memory circuit 123 receives a data signal Din for storage and then sends the data signal Din to the comparator 124, the comparator 124 receives the counting signal and the data signal Din, and performs a comparison, generating a drive signal according to the comparison results. The drive signal is configured to subsequently drive a light-emitting component, for example, the drive signal may be sent to a current source circuit, and the current source circuit drives a light-emitting component to make the light-emitting component be turned on according to the drive signal.

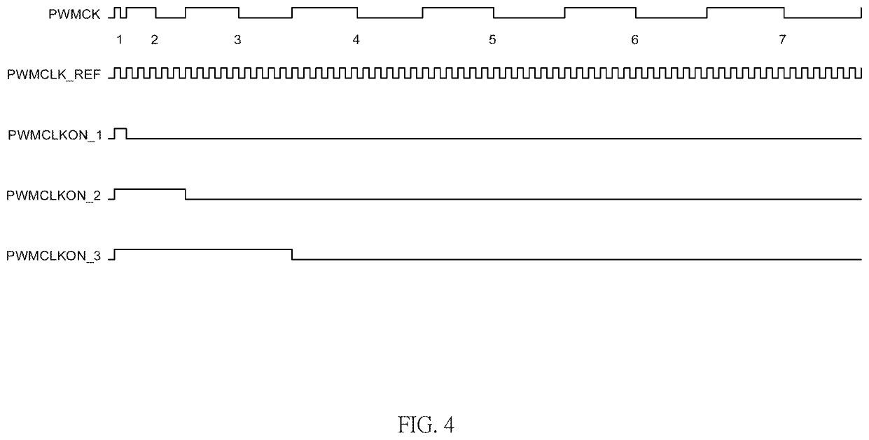

Please refer to FIG. 4, which is a schematic diagram of the display clock signal, reference display clock signal, and activating clock signal according to an embodiment of the present application. In this embodiment, for example, the data signal Din is 3-bit data, corresponding to a gamma curve. The controller 110 adjusts the frequency of the display clock signal PWMCK to correspond the data signal Din. In an embodiment, the controller 110 adjusts the frequency of the display clock signal PWMCK to correspond the grayscale value of the data signal Din. For example, the 3-bit data signal Din has grayscale values from 0 to 7, and the controller 110 sets the display clock signal PWMCK to 0, 1, 6, 15, 26, 37, 50, 63 respectively, corresponding to the grayscale values of the data signal Din from 0 to 7. As shown in FIG. 4, the controller 110 adjusts the frequency of the display clock signal PWMCK, according to the aforementioned grayscale values. A reference display clock signal PWMCLK_REF is a PWM signal with high and low levels set at 1 unit, Compared to the reference display clock signal PWMCLK_REF, the high level of the display clock signal PWMCK corresponding to a grayscale value of 0 is 0 units, meaning no display, the high level of PWM signal number 1 corresponding to a grayscale value of 1 is 1 unit, and the high level of PWM signal number 2 corresponding to a grayscale value of 2 is 5 units, the high level of PWM signal number 3 corresponding to a grayscale value of 3 is 9 units, the unit difference in the high and low levels of each numbered PWM signal corresponds to the difference from the previous PWM signal, therefore, the high level of PWM signal number 4 corresponding to a grayscale value of 4 is 26 minus 15, equaling 11 units, and so forth. The high level of PWM signal number 7 corresponding to a grayscale value of 7 is 13 units, using the above method, a 3-bit display clock signal PWMCK may achieve 6-bit data resolution capability. In an embodiment, the data signal Din is 8-bit data, and through the above method, an 8-bit display clock signal PWMCK may achieve 14-bit data resolution capability, whereas the original 14-bit display clock signal PWMCK required a frequency of 16384 units, the 8-bit display clock signal PWMCK only needs a frequency of 256 units, using the aforementioned method, the frequency of the clock signal PWMCK may be reduced to 1/64, and the relative power consumption is also reduced to 1/64, significantly reducing power consumption.

Furthermore, please refer again to FIG. 4, in this embodiment, for ease of explanation, activating clock signals PWMCLKON_1, PWMCLKON_2, and PWMCLKON_3 are taken for examples, but this is not limited to these instances. The activating clock signals PWMCLKON_1, PWMCLKON_2, and PWMCLKON_3 respectively correspond to the activation times of PWM signals numbered 1, 2, and 3 in the display clock signal PWMCLK. When the display clock signal PWMCLK is sent to the driver 120 and drives the light-emitting component, during the timing of the PWM signal numbered 1, the activation time of the light-emitting component corresponds to the high-level timing of the activating clock signal PWMCLKON_1, during the timing of the PWM signal numbered 2, the activation time of the light-emitting component corresponds to the high-level timing of the activating clock signal PWMCLKON_2, during the timing of the PWM signal numbered 3, the activation time of the light-emitting component corresponds to the high-level timing of the activating clock signal PWMCLKON_3, and so forth.

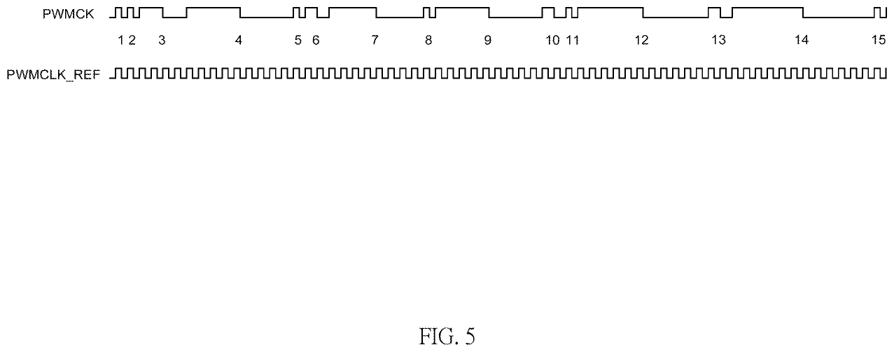

Please refer to FIG. 5, which is a schematic diagram of the display clock signal in another embodiment of the present application. In this embodiment, for example, the data signal Din is 3-bit data, which includes a first data signal, a second data signal, and a third data signal, wherein each data signal corresponds to a different gamma curve, for instance, the color corresponding to the first data signal is red, the color corresponding to the second data signal is green, and the color corresponding to the third data signal is blue. The controller 110 adjusts the frequency of the display clock signal PWMCK to correspond the grayscale values of the first, second, and third data signals.

For example, the grayscale values of the first data signal, second data signal, and third data signal of 3-bit range from 0 to 7. The controller 110 sets the display clock signal PWMCK as 0, 1, 6, 15, 26, 38, 50, 63 corresponding to the grayscale values of the first data signal from 0 to 7, respectively. The controller 110 sets the display clock signal PWMCK as 0, 1, 6, 16, 27, 39, 51, 63 corresponding to the grayscale values of the second data signal from 0 to 7, respectively. The controller 110 sets the display clock signal PWMCK as 0, 1, 6, 15, 26, 38, 50, 63 corresponding to the grayscale values of the third data signal from 0 to 7 as 0, 2, 6, 15, 27, 39, 51, 63, respectively. Subsequently, the aforementioned values are sorted from smallest to largest as 0, 1, 2, 6, 15, 16, 26, 27, 38, 39, 50, 51, 63, and the controller 110 adjusts the frequency of the display clock signal PWMCK according to the aforementioned values. In an embodiment, arbitrary unused values, such as 18 and 36, may be filled, resulting in a sorted sequence of 0, 1, 2, 6, 15, 16, 18, 26, 27, 36, 38, 39, 50, 51, 63. Then, according to the differences between the before and after filled values, the display clock signal PWMCK is set to adjust its frequency. Compared with the reference display clock signal PWMCLK_REF, the amplitude levels of the adjusted display clock signal PWMCK are a sorted sequence of 0 units, 1 unit, 1 unit, 4 units, 9 units, 1 unit, 2 units, 8 units, 1 unit, 9 units, 2 units, 1 unit, 11 units, 2 units, 12 units, 1 unit, as the display clock signal PWMCK shown in the FIG. 5.

Using the aforementioned values as an example, the display clock signal PWMCK may be implemented with 4 bits, representing the data resolution capability of 6 bits by using 4 bits, that is, representing higher bit data resolution with fewer bits. In this embodiment, at least one driver 120 includes a counter 124, which receives the frequency-adjusted display clock signal PWMCK to drive a plurality of light-emitting components.

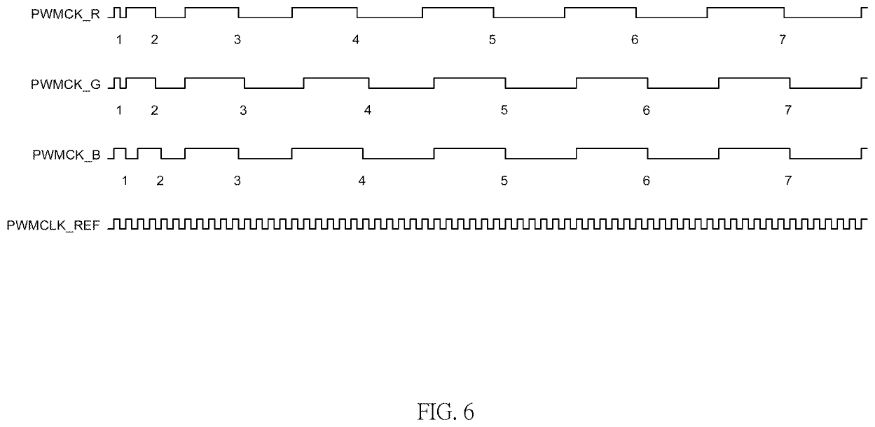

Please refer to FIG. 6, which is a schematic diagram of the display clock signal data in another embodiment of the present application. In this embodiment, for example, the data signal Din is 3-bit data, which includes a first data signal, a second data signal, and a third data signal, corresponding to three different gamma curves. For instance, the color corresponding to the first data signal is red, the color corresponding to the second data signal is green, and the color corresponding to the third data signal is blue, and the display clock signal data PWMCK includes a first display clock signal PWMCK_R, a second display clock signal PWMCK_G, and a third display clock signal PWMCK_B. The controller 110 generates the first display clock signal PWMCK_R, the second display clock signal PWMCK_G, and the third display clock signal PWMCK_B according to the grayscale values of the first, second, and third data signals respectively.

For example, the grayscale values of the first, second, and third data signals of 3-bit range from 0 to 7, and the controller 110 sets the first display clock signal PWMCK_R as 0, 1, 6, 15, 26, 38, 50, 63 corresponding to the grayscale values of the first data signal from 0 to 7, respectively, and sets the second display clock signal PWMCK_G as 0, 1, 6, 16, 27, 39, 51, 63 corresponding to the grayscale values of the second data signal from 0 to 7, respectively, and sets the third display clock signal PWMCK_B as 0, 2, 6, 15, 27, 39, 51, 63 corresponding to the grayscale values of the third data signal from 0 to 7, respectively. The controller 110 adjusts the frequencies of the first display clock signal PWMCK_R, the second PWMCK_G, and the third display clock signal PWMCK_B according to the aforementioned values, using methods as described in the embodiments of FIGS. 4 and 5, which are not elaborated here. The frequencies of the adjusted first display clock signal PWMCK_R, the adjusted second PWMCK_G, and the adjusted third display clock signal PWMCK_B are as shown in FIG. 6.

Using the aforementioned values as an example, the 3-bit first display clock signal PWMCK_R, the 3-bit second display clock signal PWMCK_G and the 3-bit third display clock signal PWMCK_B may realize 6-bit data resolution capability. In this embodiment, at least one driver 120 includes a first counter, a second counter, and a third counter, correspondingly receive the first display clock signal PWMCK_R, the second display clock signal PWMCK_G, and third display clock signal PWMCK_B with adjusted frequencies to drive the corresponding light-emitting components.

The light-emitting components of the present application may be micro LEDs, mini LEDs, or other light-emitting components, and the display panel 100 may be a micro LED panel, mini LED panel, or other light-emitting component display panel.

Through the driving structure of this case, the driving panel may utilize electronic components with lower bit counts, reducing the area occupied by electronic components and significantly lowering the dynamic power of the driving panel.

Therefore, the present application indeed possesses novelty, progressiveness, and industrial applicability, undoubtedly meeting the patent application requirements of our country's patent law. Accordingly, a patent application is filed in accordance with the law, earnestly praying for the patent grant at the earliest convenience.

However, the above description is merely an embodiment of the present application and is not intended to limit the scope of implementation of the present application. Therefore, all equivalent modifications and variations according to the structure, features, and spirit described in the patent scope of the present application should be included within the scope of this patent application.

What is claimed is:

1. A driving structure for a display panel, comprising:
a controller, disposed on the display panel, generating a data signal and a display clock signal; and
at least one driver, disposed on the display panel, receiving the data signal and the display clock signal, wherein the controller adjusts a frequency of the display clock signal to correspond the data signal.

2. The driving structure of claim 1, wherein the controller adjusts the frequency of the display clock signal according to grayscale value of the data signal.

3. The driving structure of claim 1, wherein the data signal comprises a first data signal, a second data signal and a third data signal, and the controller adjusts the frequency of the display clock signal according to grayscale values of the first data signal, the second data signal and the third data signal.

4. The driving structure of claim 3, wherein the at least one driver comprises a counter, receiving the display clock signal to drive a plurality of light-emitting components.

5. The driving structure of claim 1, wherein the data signal comprises a first data signal, a second data signal and a third data signal, and the display clock signal comprises a first display clock signal, a second display clock signal and a third display clock signal, the controller generates the first display clock signal, the second display clock signal and the third display clock signal according to the grayscale values of the first display clock signal, the second display clock signal and the third display clock signal.

6. The driving structure of claim 5, wherein the at least one driver comprises a plurality of counters, the plurality of counters comprise a first counter, a second counter and a third counter, the first counter receives the first display clock signal, the second counter receives the second display clock signal, and the third counter receives the third display clock signal.

7. The driving structure of claim 1, wherein the controller comprises a display clock signal generator, the display clock signal generator generates the display clock signal according to the content of the data signal.

8. The driving structure of claim 1, wherein the controller generates an enable signal to the at least one driver, and the at least one driver begins to receive the data signal and the display clock signal according to the enable signal.

9. The driving structure of claim 8, wherein the at least one driver comprises a first driver and a second driver, the first driver is connected to the second driver in series, and the first driver generates another enable signal to the second driver after the first driver receives the enable signal.

10. The driving structure of claim 1, wherein the controller generates a data clock signal to the at least one driver, and the at least one driver receives the data signal according to the data clock signal.

11. The driving structure of claim 10, wherein the at least one driver comprises a first driver and a second driver, the first driver is connected to the second driver in series, the first driver transmits the display clock signal to the second driver after the first driver receives the display clock signal.
